(19) United States
(12) Patent Application Publication
(10) Pub. No.: US 2024/0111543 A1
(43) Pub. Date: Apr. 4, 2024

(54) CONCURRENT EXECUTION AND COPY OF UPDATED BASIC INPUT/OUTPUT SYSTEM INSTRUCTIONS

(71) Applicant: Hewlett-Packard Development Company, L.P., Spring, TX (US)

(72) Inventors: Rosilet Retnamoni Braduke, Spring, TX (US); Mason Gunyuzlu, Spring, TX (US); Wei Ze Liu, Spring, TX (US)

(73) Assignee: Hewlett-Packard Development Company, L.P., Spring, TX (US)

(21) Appl. No.: 18/554,394

(22) PCT Filed: Apr. 28, 2021
(86) PCT No.: PCT/US2021/029707

§ 371 Date: Oct. 6, 2023

(51) Int. Cl. G06F 9/4401

(52) U.S. Cl. CPC G06F 9/4403

(57) ABSTRACT

An example apparatus is described for concurrent execution and copy of updated basic input/output system (“BIOS”) instructions. The apparatus may comprise a private serial peripheral interface and a processor to execute updated BIOS instructions. The apparatus may also comprise a controller to copy the updated BIOS instructions to the private serial peripheral interface. In various examples, execution and copy of the updated BIOS instructions may be performed concurrently.

### BACKGROUND

An apparatus may employ non-transitory machine-readable storage media to perform various functions. For example, basic input/output system (“BIOS”) instructions may be executed to perform functions when the apparatus initially starts up.

### BRIEF DESCRIPTION OF THE DRAWINGS

FIG. 1 illustrates a block diagram of an example, non-limiting apparatus that may capture updated BIOS instructions to a private memory in accordance with examples described herein.

FIG. 2 illustrates a block diagram of an example, non-limiting apparatus that may concurrently copy updated BIOS instructions to a private serial peripheral interface and execute the updated BIOS instructions from a memory in accordance with examples described herein.

FIG. 3 illustrates a block diagram of an example, non-limiting non-transitory machine-readable storage medium that may comprise instructions to capture the updated BIOS instructions to the private serial peripheral interface in accordance with examples described herein.

FIG. 4 illustrates a block diagram of the example, non-limiting non-transitory machine-readable storage medium that may further comprise instructions to copy at least a boot block and/or driver execution region of the updated BIOS instructions to the private serial peripheral interface in accordance with examples described herein.

FIG. 5 illustrates a flow diagram of an example, non-limiting process that may be employed by a processor to update BIOS instructions in accordance with examples described herein.

FIG. 6 illustrates a flow diagram of an example, non-limiting process that may be employed by a controller to detect BIOS instructions update in accordance with examples described herein.

FIG. 7 illustrates a flow diagram of an example, non-limiting process that may be employed by the controller to utilize internal state machine variables in effectuating a backup operation of BIOS instructions in accordance with examples described herein.

FIG. 8 illustrates flow diagrams of example, non-limiting processes that may be employed by the controller and the processor concurrently to capture the updated BIOS instructions and execute the updated BIOS instructions in accordance with examples described herein.

FIG. 9 illustrates a flow diagram of an example, non-limiting computer-implemented method that may be employed by an apparatus to concurrently copy updated BIOS instructions to a private serial peripheral interface and execute the updated BIOS instructions from a memory in accordance with examples described herein.

FIG. 10 illustrates a block diagram of the example, non-limiting apparatus that may further comprise a user interface that may be employed to initiate a BIOS update operation by the processor in accordance with examples described herein.

### DETAILED DESCRIPTION

The following detailed description is merely illustrative and is not intended to limit examples and/or application or uses of examples. Furthermore, there is no intention to be bound by any expressed or implied information presented in the preceding Background section, or in the Detailed Description section.

Instructions of non-transitory machine-readable storage media may be included in a BIOS employed by an apparatus to perform various functions, such as a startup operation. For example, the non-transitory machine-readable storage media instructions may be executable by a processor of the apparatus. The BIOS may, for instance, initialize various components of the apparatus and/or load an operating system employed by the apparatus. For example, the BIOS may check hardware components of the apparatus to ensure proper functionality upon startup. Further, the BIOS may operate as part of a power-on self-test (“POST”) procedure of the apparatus.

In some instances, the non-transitory machine-readable storage media instructions of the BIOS may experience a failure and/or corruption that prompts a restore operation. BIOS instructions may be considered corrupted when the non-transitory machine-readable storage media instructions have been tampered with in an unauthorized manner, and/or when the non-transitory machine-readable storage media instructions no longer function in an expected manner For example, when the BIOS becomes corrupted, restoring the BIOS to a previously stored state may remedy operating deficiencies and/or security concerns caused by the corruption. Thus, apparatuses may employ a backup operation to capture a desirable state of the BIOS instructions to a non-volatile memory for future retrieval. Further, the BIOS instructions may be updated over time to alter operation of the BIOS. With each update, the apparatus may perform a backup operation to capture the updated BIOS instructions. However, the backup operation may extend the duration of the startup operation. For instance, the backup operation may prolong the time in which the apparatus is in an off state, and/or is executing the POST procedure.

Various examples described herein may be directed to computer processing devices, computer-implemented methods, apparatuses and/or computer program products that facilitate the efficient, effective, and autonomous (e.g., without direct human guidance) copying and/or execution of updated BIOS instructions. For instance, apparatuses and/or machine-readable storage media described herein may concurrently capture and execute updated BIOS instructions, thereby reducing delays in startup operations following the update to the BIOS. As used herein, the term “concurrent” and/or “concurrently” may refer to the performance of at least two operations during overlapping time periods and/or in parallel with each other. For example, concurrent operations, such as capture and execution of updated BIOS instructions, may be: initialized at the same time, and/or performed such that a time period in which one operation is performed overlaps another time period in which the other operation is performed. In various examples, a controller of an apparatus may copy the updated BIOS instructions to a private, non-volatile memory. Also, a processor of the apparatus may execute the updated BIOS instructions to initialize a startup operation and/or a POST procedure. Further, the backup operation by the controller and the updated BIOS execution by the processor may be performed concurrently with each other.

The computer processing devices, computer-implemented methods, apparatuses and/or computer program products employ hardware and/or machine-readable storage media to perform functions that are highly technical in nature, that are not abstract. Also, various examples described herein may constitute a technical improvement to the apparatuses described herein by improving processor efficiency and/or reducing delays in the apparatus startup and/or POST procedure following a BIOS update. Additionally, various examples described herein may demonstrate a technical improvement to the apparatuses described herein by incorporating a signature verification operation into the backup operation, which may enhance the apparatus security protocols.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

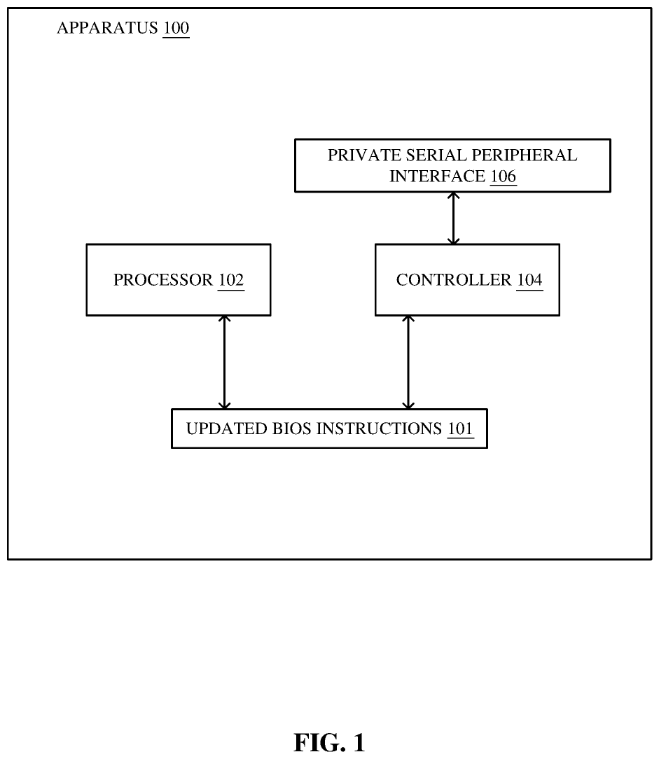

FIG. 1 illustrates a block diagram of an example, non-limiting apparatus 100 that may concurrently execute and copy updated BIOS instructions 101. Repetitive description of like elements employed in other examples described herein is omitted for the sake of brevity. Although aspects and/or features may in some cases be described with regard to respective figures, it will be appreciated that features from one figure or example may be combined with features of another figure or example even though the combination is not explicitly shown or explicitly described as a combination. As such, FIG. 1 may include more or fewer aspects than those illustrated. Additionally, the functional blocks in FIG. 1 may be circuits configured or coded by design and/or by configurable circuitry.

As shown in FIG. 1, the apparatus 100 may comprise a processor 102, controller 104, and/or a private serial peripheral interface 106. In various examples, the apparatus 100 may be a computing device. For instance, example types of apparatus 100 may include, but are not limited to: desktop computers; notebook computers; laptop computers; tablet computers; smart devices, such as smart phones, smart watches, smart eyeglasses, and/or other wearable devices; server computers; computer nodes, such as storage and/or network nodes; computerized vehicles; a combination thereof; and/or the like.

The apparatus 100 may employ the processor 102 to update and/or execute BIOS instructions. Further, the apparatus 100 may employ the processor 102 to execute an OS, a computer program, an application code, and/or the like. Example types of processors 102 may include, but are not limited to: central processing units (“CPUs”), microprocessors, cores of a multi-core microprocessors, microcontrollers, programmable integrated circuits (“ICs”), programmable gate arrays (“PGAs”), hardware processing circuits, digital signal processors, media processors, application-specific system processors (“ASSPs”), application-specific instruction set processors (“ASIPs”), and/or the like. In various examples, the apparatus 100 may comprise multiple processors 102 with the characteristics and/or functionality described for processor 102 or other processors described herein.

The apparatus 100 may employ the controller 104 to perform a backup operation of the BIOS instructions. The controller 104 may be an embedded controller that performs tasks governed by an embedded non-transitory machine-readable storage medium. In various examples, the controller 104 may be a hardware-based root of trust for the apparatus 100. Example types of controllers 104 may include, but are not limited to: microcontrollers, application-specific integrated circuits (“ASICs”), PGAs, programmable circuits, a super input/output chip, and/or the like. In various examples, the processor 102 and the controller 104 are physically separate components of the apparatus 100. The processor 102 and the controller 104 may be mounted on the same circuit board or on separate circuit boards. In some examples, the processor 102 and the controller 104 may be provided within the same housing of the apparatus 100, as shown in FIG. 1.

The updated BIOS instructions 101 may upgrade the BIOS instructions employed by the apparatus 100. For example, the updated BIOS instructions 101 may modify and/or replace the BIOS instructions of an existing BIOS on the apparatus 100 to: alter functionality of the BIOS, enhance operation of the BIOS, enable the BIOS to perform new functionality, a combination thereof, and/or the like. In another example, the updated BIOS instructions 101 may establish new BIOS instructions in the apparatus 100, rather than upgrading existing BIOS instructions.

In various examples, the processor 102 may execute the updated BIOS instructions 101. Further, the controller 104 may perform a backup operation that captures the updated BIOS instructions 101 to the private serial peripheral interface 106. For example, the controller 104 may generate internal state machine variables to effectuate the capture of the updated BIOS instructions 101 based on a detection of the updated BIOS instructions. The controller 102 may generate a copy of a boot block of the updated BIOS instructions 101 and/or a copy of a driver execution region of the updated BIOS instructions 101 via the internal state machine variables. Additionally, the execution performed by the processor 102 and the backup operation performed by the controller may be performed concurrently.

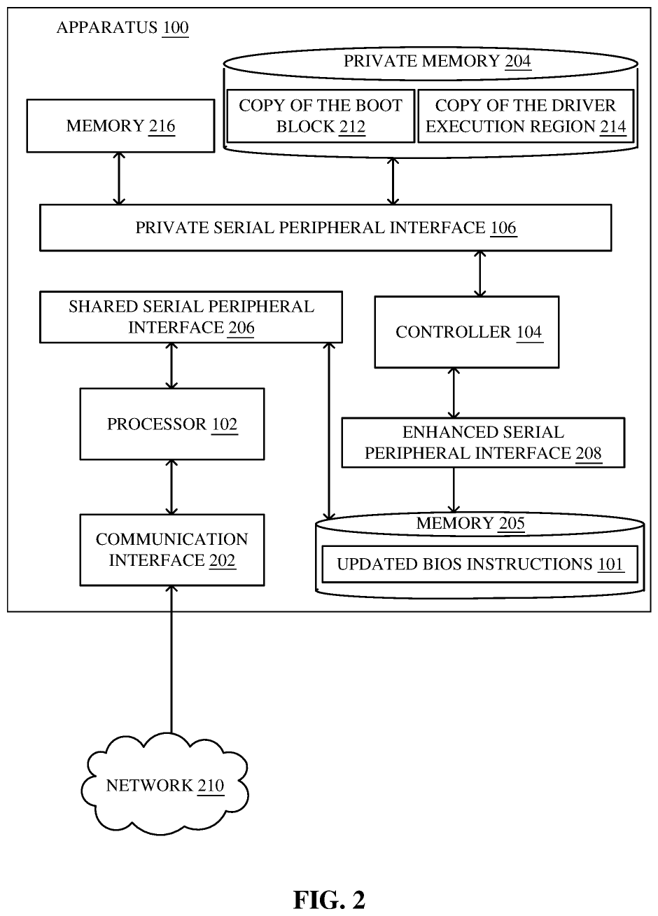

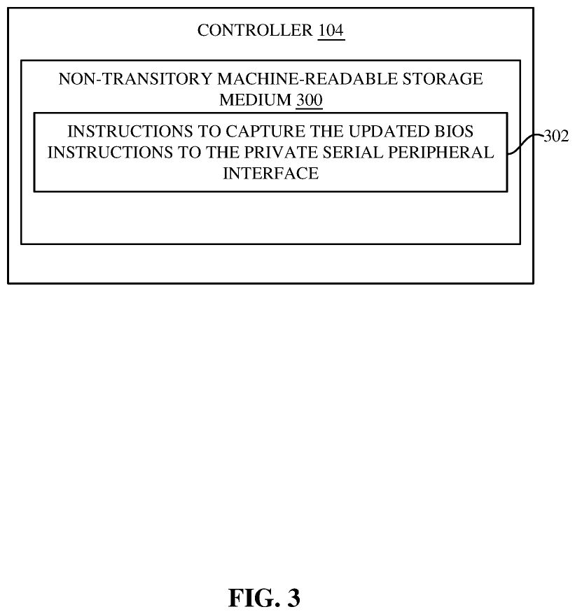

FIG. 2 illustrates a diagram of the example, non-limiting apparatus 100 further comprising a communication interface 202, a private memory 204, and a memory 205 in accordance with various examples described herein. FIG. 3 illustrates a block diagram of the example, non-limiting controller 104 comprising a non-transitory machine-readable storage medium 300, where the term “non-transitory” does not encompass transitory propagating signals. Repetitive description of like elements employed in other examples described herein is omitted for the sake of brevity.

Referring first to FIG. 2, the apparatus 100 may further comprise a shared serial peripheral interface 206 that may couple to various components such as, but not limited to: the processor 102, the communication interface 202, and/or the memory 205. Additionally, the private serial peripheral interface 106 may couple to various components such as, but not limited to: the controller 104 and/or the private memory 204. Further, an enhanced serial peripheral interface 208 may couple the controller 104 to the memory 205. In various examples, the shared serial peripheral interface 206 may also be accessible to the controller 104, either directly or via the enhanced serial peripheral interface 208.

In various examples, the apparatus 100 may communicate with a network 210 via communication interface 202. The communication interface 202 may comprise hardware components and/or non-transitory machine-readable storage media instructions for controlling access to resources of the apparatus 100 by the network 210. For instance, the communication interface 202 may control an exchange of information with the network 210, which may include the updated BIOS instructions 101 employed by the apparatus 100. The network 210 may comprise wired and wireless networks, including, but not limited to, a cellular network, a wide area network (“WAN”), such as the Internet, or a local area network (“LAN”). For example, the apparatus 100 may receive the updated BIOS instructions 101 using virtually any desired wired or wireless technology including for example, but not limited to: cellular, WAN, wireless fidelity (“Wi-Fi”), Wi-Max, WLAN, Bluetooth technology, a combination thereof, and/or the like.

The memory 205 may be operably coupled to the processor 102 and the controller 104, thereby being a shared memory. In various examples, the memory 205 may be a non-volatile memory, where the content of the memory 205 is maintained even when electrical power is removed from the memory 205. Example types of memory 205 may include, but are not limited to: a flash memory device, a memristor memory, a spin-transfer torque memory device, a phase change memory device, a disk-based storage device, and/or the like. Additionally, updated BIOS instructions 101 may be stored in the memory 205 for execution by the processor 102 and/or capture by the controller 104.

For example, the updated BIOS instructions 101 may be accessible to the processor 102 via the shared serial peripheral interface 206. Additionally, the updated BIOS instructions 101 may be accessible to the controller 104 via the enhanced serial peripheral interface 208. However, the private memory 204 may be accessible to the controller 104 and inaccessible the processor 102. In various examples, the private memory 204 is accessible to the controller 104 via the private serial peripheral interface 106. The private memory 204 may be a non-volatile memory, where the content of the private memory 204 is maintained even when electrical power is removed from the private memory 204. Example types of private memory 204 may include, but are not limited to: a flash memory device, a memristor memory, a spin-transfer torque memory device, a phase change memory device, a disk-based storage device, and/or the like.

In various examples, a copy of the BIOS instructions (not shown) employed by the apparatus 100 may be stored in the private memory 204. For example, a copy of the boot block 212 of the BIOS instructions may be stored in the private memory 204. Further, a copy of the driver execution region 214 of the BIOS instructions may also be stored in the private memory 204. In an additional example, the apparatus 100 may further comprise a memory 216 to facilitate capture of the copy of the boot block 212. For example, the memory 216 may be a temporary memory space. As used herein, the term “temporary memory space” may mean memory space employed to temporarily store data. For example, a temporary memory space may be an intermediate storage location employed in a data transfer operation. During a data transfer, the data may be copied, and/or otherwise relocated, from a source location to a temporary memory space. The data may then be relocated from the temporary memory space to a designated destination. As shown in FIG. 2, the controller 104 may access the memory 216 via the private serial peripheral interface 106. Example types of memory 216 include, but are not limited to: scratchpad memory, random access memory (“RAM”), cache memory, non-volatile random-access memory (“NVRAM”), a combination thereof. When the apparatus 100 executes a restore operation to return the BIOS instructions to a previous state, the controller 104 may retrieve the stored copy of the boot block 212 and/or copy of the driver execution region 214 to be implemented in the restore operation. Thus, the BIOS instructions (not shown) stored in the memory 205 may be executable by the processor 102, and the BIOS instructions stored in the private memory 204 may be retrievable by the controller 104 to facilitate a restore operation of the BIOS instructions.

In some examples, the apparatus 100 may perform a restore operation based on a determination that the BIOS instructions stored in the memory 205 are corrupted. Since access to the private memory 204 is restricted, in comparison to the memory 205, the BIOS instructions stored in the private memory 204 is less likely to have become corrupted and may thereby be employed to restore the BIOS instructions to a desired state.

In accordance with various examples described herein, the apparatus 100 may receive the updated BIOS instructions 101 from the network 210 and store the updated BIOS instructions 101 in the memory 205. Once stored in the memory 205, the processor 102 may update the BIOS instructions employed by the apparatus 100 to match the updated BIOS instructions 101. Additionally, the controller 104 may copy the updated BIOS instructions 101 to the private serial peripheral interface 106. For example, the controller 104 may generate a copy of the boot block 212 of the updated BIOS instructions 101 and store the copy of the boot block 212 of the updated BIOS instructions 101 in the memory 216 via the private serial peripheral interface 106. Further, the controller 104 may generate a copy of the driver execution region 214 of the updated BIOS instructions 101, and store the copy of the driver execution region 314 of the updated BIOS instructions 101 in the private memory 204 via the private serial peripheral interface 106. While the copy of the boot block 212 of the updated BIOS instructions 101 is stored in the memory 216, the controller 104 may perform a signature verification operation. Based on a successful signature verification operation, the controller 104 may relocate the copy of the boot block 212 of the updated BIOS instructions 101 from the memory 216 to the private memory 204 via the private serial peripheral interface 106. In various examples, the processor 102 may execute the updated BIOS instructions 101 concurrently with the controller 104 copying the updated BIOS instructions 101 to the private memory 204 via the private serial peripheral interface 106.

Referring to FIG. 3, the non-transitory machine-readable storage medium 300 may be encoded with instructions executable by the controller 104. For example, the non-transitory machine-readable storage medium 300 may be encoded with non-transitory machine-readable storage media instructions 302 to capture the updated BIOS instructions 101 to the private serial peripheral interface 106.

In various examples, the processor 102 may update a BIOS based on the updated BIOS instructions 101, which may be received by the network 210 and/or stored in the memory 205. Upon updating the BIOS, the copy of the BIOS instructions stored in the private memory 204, such as the copy of the boot block 212 and/or the copy of the driver execution region 214, becomes outdated. Performing a restore operation with the outdated copy of the BIOS instructions may result in the restoration of an undesirable version the BIOS instructions. By updating the copy of the BIOS instructions stored in the private memory 204 along with updating the copy of the BIOS instructions stored in the memory 205 based on the updated BIOS instructions 101, subsequent restore operations may return the BIOS instructions to a desired state and/or version. In various examples, the non-transitory machine-readable storage media instructions 302 to capture the updated BIOS instructions 101 to the private serial peripheral interface 106 may enable the controller 104 to maintain a latest version of the BIOS instructions in the private memory 204 based on the updated BIOS instructions in the memory 205. For instance, the copy of the boot block 212 and/or the copy of the driver execution region 214 may be copied from the updated BIOS instructions 101. Further, in various examples, the non-transitory machine-readable storage media instructions 302 to capture the updated BIOS instructions 101 to the private serial peripheral interface 106 may be executed by the controller 104 concurrently with execution of the updated BIOS instructions 101 by the processor 102 from the memory 205.

In various examples, the non-transitory machine-readable storage medium 300 may include a single form of computer memory or multiple forms of computer memory. The non-transitory machine-readable storage medium 300 may be an electronic, magnetic, optical, or other physical storage device that stores executable non-transitory machine-readable storage media instructions. Thus, the non-transitory machine-readable storage medium 300 may be, for example, RAM, an electrically-erasable programmable read-only memory (“EEPROM”), a storage drive, an optical disc, and/or the like. Additionally, although FIG. 3 depicts non-transitory machine-readable storage media instructions on a single non-transitory machine-readable storage medium 300, the architecture of the apparatus 100 is not so limited. Examples in which the non-transitory machine-readable storage media instructions may be included in multiple non-transitory machine-readable storage media 300 are also envisaged. In various examples, the non-transitory machine-readable storage media instructions may be located within the apparatus 100 or located in a remote device from which the non-transitory machine-readable storage media instructions may be downloaded via the communication interface 202 and/or network 210.

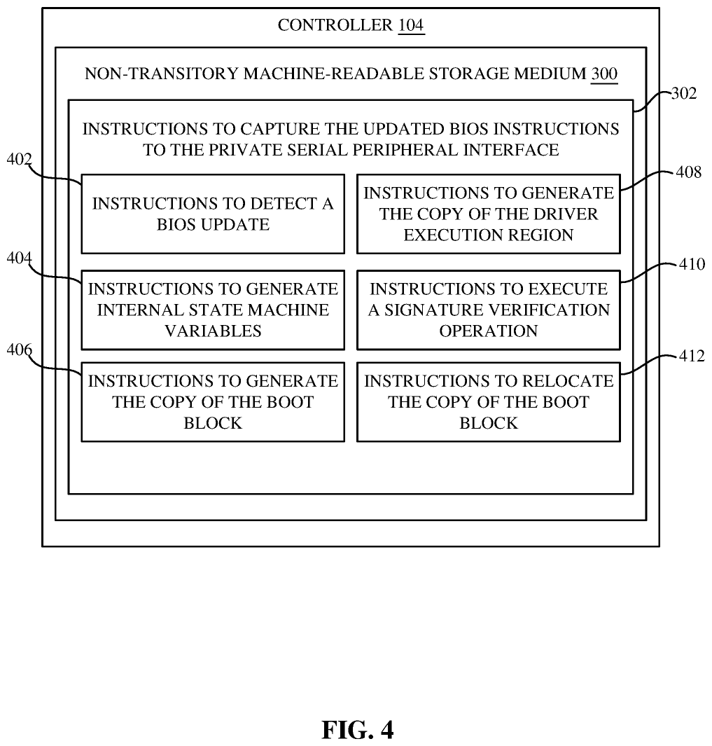

FIG. 4 illustrates the example, non-limiting controller 104 comprising the non-transitory machine-readable storage media instructions 302 to capture the updated BIOS instructions 101 to the private serial peripheral interface 106, and further comprising a subset of non-transitory machine-readable storage media instructions in accordance with various examples described herein. Repetitive description of like elements employed in other examples described herein is omitted for the sake of brevity. In various examples, the non-transitory machine-readable storage media instructions 302 to capture the updated BIOS instructions 101 to the private serial peripheral interface 106 may include: non-transitory machine-readable storage media instructions 402 to detect a BIOS update, non-transitory machine-readable storage media instructions 404 to generate internal state machine variables, non-transitory machine-readable storage media instructions 406 to generate the copy of the boot block 212, non-transitory machine-readable storage media instructions 408 to generate the copy of the driver execution region 214, non-transitory machine-readable storage media instructions 410 to execute a signature verification operation, and/or non-transitory machine-readable storage media instructions 412 to relocate the copy of the boot block 212. The controller 104 may execute the various non-transitory machine-readable storage media instructions of the non-transitory machine-readable storage medium 300 to perform various functions that effectuate the capture of the updated BIOS instructions 101 to the private memory 204, via the private serial peripheral interface 106, in a backup operation. For example, the non-transitory machine-readable storage media instructions of the non-transitory machine-readable storage medium 300 may be executed by the controller 104 in accordance with methods 600, 700, 800, and/or 900 described herein.

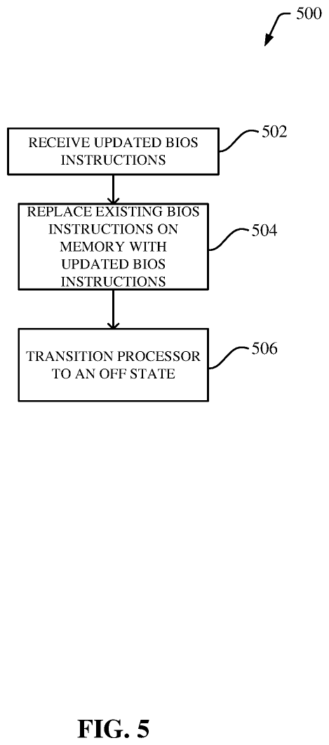

FIG. 5 illustrates a flow diagram of an example, non-limiting method 500 that may be employed by the processor 102 to update the BIOS instructions of the apparatus 100 in accordance with examples described herein. Repetitive description of like elements employed in other examples described herein is omitted for the sake of brevity. At 502, the apparatus 100 may receive the updated BIOS instructions 101. For example, the updated BIOS instructions 101 may be received from the network 210 via the communication interface 202. In various examples, an existing version of the BIOS instructions may be already stored in the memory 205. At 504, the processor 102 may replace the existing BIOS instructions with the updated BIOS instructions 101 in the memory 205. For example, the processor 102 may modify the BIOS instructions stored in the memory 205 in accordance with, and/or to match, the updated BIOS instructions 101. In another example, the processor 102 may remove the existing BIOS instructions from the memory 205 and in its place store the updated BIOS instructions 101. In a further example, the processor 102 may store the updated BIOS instructions 101 in the memory 205 in addition to the existing BIOS instructions and flag the updated BIOS instructions 101 as the default instructions for execution. Thereby, the processor 102 may perform a BIOS update that results in the updated BIOS instructions 101 through the shared serial peripheral interface 206 being stored in the memory 205 for later execution. At 506, the processor 102 may transition to an off state after completing the BIOS update.

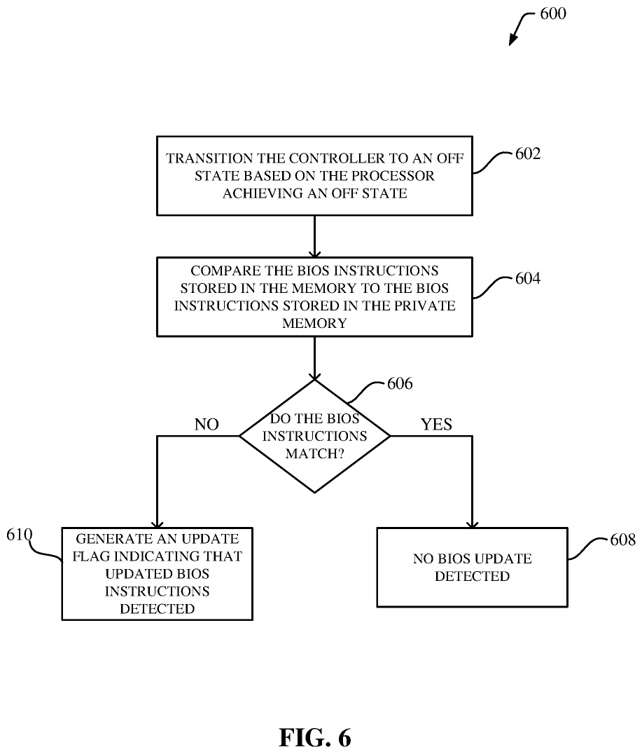

FIG. 6 illustrates a flow diagram of an example, non-limiting method 600 that may be employed by the controller 104 to detect a BIOS update performed by the processor 102. Repetitive description of like elements employed in other examples described herein is omitted for the sake of brevity. In various examples, method 600 may be performed in accordance with the non-transitory machine-readable storage media instructions 402 included in the non-transitory machine-readable storage medium 300. At 602, the controller 104 may be transitioned to an off state based on the processor 102 achieving an off state. For example, the off state may be a state in which the controller 104 is running in a loop waiting for the processor 102 to transition to an on state. For example, while the controller 104 is in the off state the processor 102 may also be in an off state, and the controller 104 may perform the functions of method 600 in preparation of the processor 102 transitioning to an on state.

At 604, the controller 104 may compare the BIOS instructions stored in the memory 205 to the BIOS instructions stored in the private memory 204. As shown in FIG. 6, the comparison at 604 may facilitate a determination, at 606, of whether the BIOS instructions stored in the memory 205 match the BIOS instructions stored in the private memory 204. For example, the comparison at 604 may compare a version identifier included in the BIOS instructions of the memory 205 with a version identifier included in the BIOS instructions of the private memory 204. The boot block and/or driver execution region associated with the BIOS instructions may comprise major/minor version identifiers, such as version numbers. The comparison at 604 may comprise comparing the version identifiers of the BIOS instructions accessible via the shared serial peripheral interface 206 and/or the enhanced serial peripheral interface 208 versus the private serial peripheral interface 106. In various examples, multiple versions of the BIOS instructions may be stored in the memory 205, where a version may be flagged as the latest version. The comparison at 604 may be performed between the BIOS instructions stored in the private memory 204 and the latest version of the BIOS instructions stored in the memory 205, which may be the updated BIOS instructions 101 and/or a flagged version of the BIOS instructions. At 608, the controller 104 may determine that no BIOS updated was performed by the processor 102 based on the respective BIOS instructions matching each other. At 610, the controller 104 may detect the updated BIOS instructions 101, and/or that a BIOS update was performed by the processor 102, based on the respective BIOS instructions not matching each other. For example, at 610, the controller 104 may generate an update flag indicating that a BIOS update has been detected.

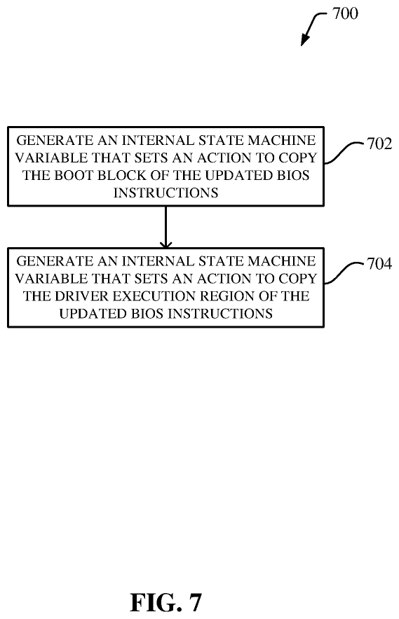

FIG. 7 illustrates a flow diagram of an example, non-limiting method 700 that may be employed by the controller 104 to generate internal state machine variables for initializing a backup operation in accordance with examples described herein. Repetitive description of like elements employed in other examples described herein is omitted for the sake of brevity. In various examples, method 700 may be performed in accordance with the instructions 404 included in the non-transitory machine-readable storage medium 300. For example, the controller 104 may perform method 700 in accordance with the non-transitory machine-readable storage media instructions 404 based on a detection of the updated BIOS instructions 101 resulting from method 600. For instance, the features of method 700 may be performed based on a detected BIOS update at 610. Further, method 700 may be performed by the controller 104 while the controller is in the off state.

At 702, the controller 104 may generate an internal state machine variable that sets an action to copy the boot block of the updated BIOS instructions 101. At 704, the controller 104 may generate an internal state machine variable that sets an action to copy the driver execution region of the updated BIOS instructions 101. In various examples, the actions set by the internal state machine variables at 702 and/or 704 may be triggered by the controller 104 transitioning to an on state.

In various examples, the features of method 700 may be performed based on a signature verification operation in addition to a detected BIOS update. For example, the controller 104 may perform a signature verification operation based on the detection of the updated BIOS instructions 101 via method 600. The updated BIOS instructions 101 may include an overall signature that may be subject to the signature verification operation to determine whether the updated BIOS instructions 101 are authentic and/or otherwise uncorrupted. Where the signature verification operation is successful, the controller 104 may generate internal state machine variables in accordance with method 700 to initiate a backup operation of the updated BIOS instructions 101 upon the controller 104 transitioning back to an on state. Where the signature verification operation fails, the controller 104 may initiate a restore operation to return the BIOS instructions to a previous state. In various examples, the signature verification operation may ascertain whether the updated BIOS instructions 101 are corrupted based on a public key infrastructure, such as: trusted identification using a certificate authority, extended validation code signing, and/or the like.

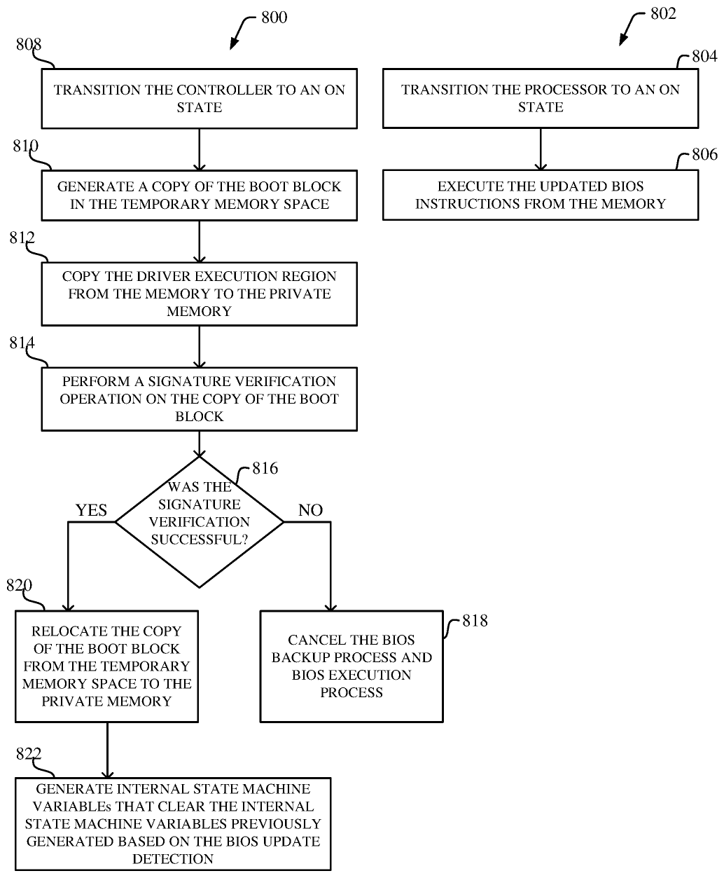

FIG. 8 illustrates a flow diagram of example, non-limiting methods 800 and 802, which may be performed concurrently in accordance with examples described herein. Repetitive description of like elements employed in other examples described herein is omitted for the sake of brevity. In various examples, method 800 may be performed by the controller 104 in accordance with the non-transitory machine-readable storage media instructions 406, 408, 410, and/or 412. Further, method 802 may be performed by the processor 102. For example, the processor 102 may perform method 802 based on a completion of method 500 by the processor 102 and/or a completion of method 700 by the controller 104. Additionally, the controller 104 may perform method 800 based on a completion of method 700. In various examples, the controller 104 may perform method 800 to copy the updated BIOS instructions 101 to the private memory 204 via the private serial peripheral interface 106.

At 804, the processor 102 may be transitioned to an on state. For example, the processor 102 may be in an off state as a result of completing method 500 and subsequently transitioned to the on state. In various examples, the processor 102 may be transitioned to the on state based on a completion of method 700 by the controller 104. In another example, the processor 102 may be transitioned to the on state following a defined time interval starting at the completion of method 500. At 806, the processor 102 may execute the updated BIOS instructions 101 from the memory 205.

Concurrent with the processor transitioning to the on state at 804 and/or executing the updated BIOS instructions 101 at 806, at 808, the controller 104 may be transitioned to an on state as well. For example, the controller 104 may be in an off state as a result of detecting a BIOS update in accordance with method 600. Further, by transitioning to the on state, the controller 104 may trigger the internal state machine variables generated in accordance with method 700. At 810, the controller 104 may generate the copy of the boot block 212 in the memory 216. For example, the controller 104 may copy the boot block of the updated BIOS instructions 101 to the memory 216. In various examples, the controller 104 may generate the copy of the boot block 212 at 810 in accordance with the non-transitory machine-readable storage media instructions 406 included in the non-transitory machine-readable storage medium 300.

Upon completion of generating the copy of the boot block 212, the method 800 may progress to 812. At 812, the controller 104 may generate the copy of the driver execution region 214 of the updated BIOS instructions 101 from the memory 205. Further, the controller 104 may store the copy of the driver execution region 214 in the private memory 204. In addition to the overall signature, the boot block and/or driver execution region of the updated BIOS instructions 101 may include respective signatures. In various examples, the controller 104 may perform a signature verification with respect to the signature of the driver execution region associated with the updated BIOS instructions 101 prior to copying the driver execution region to the private memory 205 via the private serial peripheral interface 106. The signature verification operation may ascertain whether the driver execution region of the updated BIOS instructions 101 is corrupted based on a public key infrastructure, such as: trusted identification using a certificate authority, extended validation code signing, and/or the like. Additionally, the controller 104 may generate the copy of the boot block 212 at 810 in accordance with the non-transitory machine-readable storage media instructions 406 included in the non-transitory machine-readable storage medium 300. For example, the controller 104 may copy the driver execution region of the updated BIOS instructions 101 to the private memory 204 via the private serial peripheral interface 106.

Upon completion of generating the copy of the driver execution region 214, the method 800 may progress to 814. At 814, the controller 104 may perform a signature verification operation on the copy of the boot block 212. In various examples, the controller 104 may perform the signature verification operation in accordance with the non-transitory machine-readable storage media instructions 410 included in the non-transitory machine-readable storage medium 300. In various examples, the controller 104 may perform the signature verification at 814 with respect to the signature of the copy of the boot block 212, which was copied along with the boot block associated with the updated BIOS instructions 101. During the signature verification operation, the copy of the boot block 212 may remain located in the memory 216. The signature verification operation may ascertain whether the copy of the boot block 212 is corrupted based on a public key infrastructure, such as: trusted identification using a certificate authority, extended validation code signing, and/or the like.

As shown in FIG. 8, where the signature verification operation is determined to be unsuccessful at 816, the controller 104 may cancel the BIOS backup process at 818. Additionally, the controller 104 may instruct the processor 102 to cancel and/or halt execution of the updated BIOS instructions 101. In a further example, the controller 104 may initiate a restore operation based on an unsuccessful signature verification operation, where the restore operation may restore the BIOS instructions of the memory 205 to a previous state and/or version. In various examples, an unsuccessful signature verification operation may be an indication that the copy of the boot block 212 is corrupted. By capturing the copy of the boot block 212 to the memory 216 and performing a signature verification operation, the controller 104 may avoid introducing a corrupted copy of the boot block 212 to the private memory 204.

Where the signature verification operation is determined to be successful at 816, the controller 104 may relocate the copy of the boot block 212 to the private memory 204 at 820. In various examples, the controller 104 may perform the relocation at 820 in accordance with the non-transitory machine-readable storage media instructions 412 included in the non-transitory machine-readable storage medium 300. For example, a successful signature verification may indicate that the copy of the boot block 212 is not corrupted and thereby safe to relocate into the private memory 204 via the private serial peripheral interface 106. In various examples, the private memory 204 may already be storing a boot block copy from a previous version of the BIOS instructions. For example, the controller 104 may replace the existing boot block copy associated with the previous BIOS instructions with the recently verified copy of the boot block 212 associated with the updated BIOS instructions 101. In another example, the controller 104 may store the recently verified copy of the boot block 212 associated with the updated BIOS instructions 101 along with the boot block copy associated with the previous BIOS instructions. The copy of the boot block 212 associated with the updated BIOS instructions 101 may be identifiable by a version number and/or a version flag.

Upon completion of the relocation at 820, the controller 104 may generate internal state machine variables that clear the internal state machine variables generated by method 700. For example, the internal state machine variables generated at 820 may clear the internal state machine variable that sets the action to generate the copy of the boot block 212. In another example, the internal state machine variables generated at 820 may clear the internal state machine variable that sets the action to generate the copy of the driver execution region 214. In a further example, the internal state machine variables generated at 820 may clear an update flag generated in accordance with method 600. By clearing the previously generated machine state variables generated in accordance with method 700 and/or the update flag generated in accordance with method 600, the controller 104 may avoid performing the BIOS backup operation of method 800 with each transition to the on state. Rather, the BIOS backup operation of method 800 may be reserved to instances where the controller 104 is transitioned to the on state after the processor 102 has performed a BIOS update.

In various examples, at least one of the features of method 800 may be performed concurrently with the features of method 802. For example, generation of the copy of the boot block 212 at 808 may be performed concurrently with the execution of the updated BIOS instructions 101 at 806. In another example, generation of the copy of the driver execution region 214 at 810 may be performed concurrently with the execution of the updated BIOS instructions 101 at 806. In another example, the signature verification operation at 812 may be performed concurrently with the execution of the updated BIOS instructions 101 at 806. In another example, the relocation at 820 may be performed concurrently with the execution of the updated BIOS instructions 101 at 806. In a further example, the execution of the updated BIOS instructions 101 at 806 may be performed concurrently with all of: generation of the copy of the boot block 212 at 808, generation of the copy of the driver execution region 214 at 810, the signature verification operation at 812, and relocation of the copy of the boot block 212 at 820.

In various examples, the processor 102 may initiate method 802 prior to a completion of method 800 by the controller 104. For example, execution of the updated BIOS instructions 101 at 806 may be initiated prior to completion of a capture of the updated BIOS instructions via method 800. In various examples, a time period in which the controller 104 performs method 800 may overlap a time period in which the processor 102 performs method 802. For example, a time period in which the controller 104 copies the updated BIOS instructions 101 to the private serial peripheral interface 106 via 810-820 of method 800 may overlap a time period in which the updated BIOS instructions are executed by the processor 102 via 806 of method 802. Thereby, at least one feature of method 800 may be performed in parallel with at least one feature of method 802.

In various examples, methods 800 and 802 may be initiated simultaneously, or near simultaneously. In various examples, at least one feature of method 802 may be initiated subsequent to the initialization of method 800 and prior to the completion of method 800. For example, execution of the updated BIOS instructions 101 at 806 may be initiated by the processor 102 subsequent to initialization of method 800 and prior to the completion of method 800. In various examples, the processor 102 may further execute an OS, where the features of method 800 may be performed by the controller 104 prior to execution of the OS by the processor.

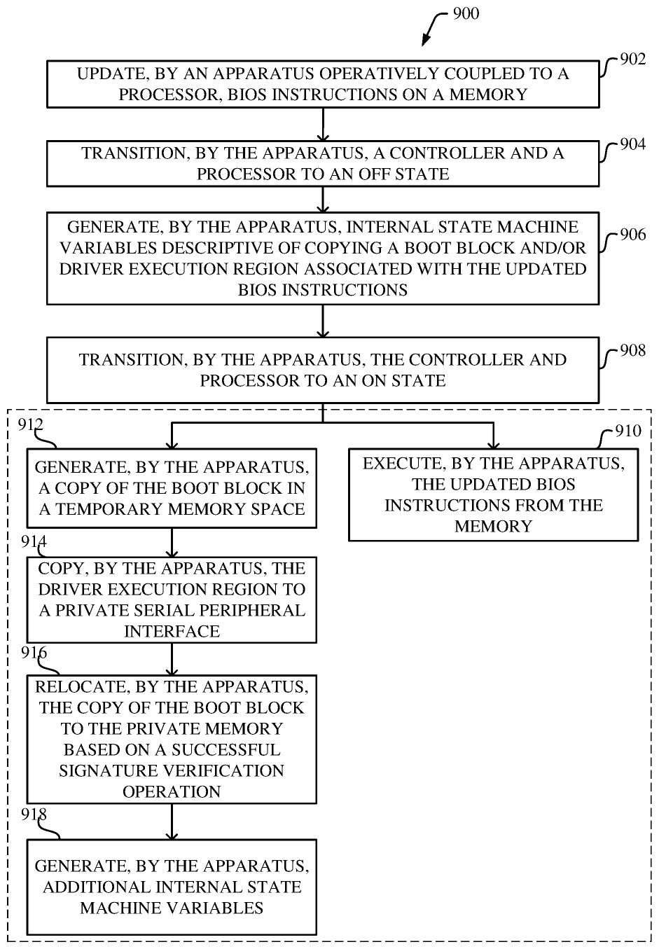

FIG. 9 illustrates a flow diagram of an example, non-limiting computer-implemented method 900 that may be performed by the apparatus 100 in accordance with examples described herein. Repetitive description of like elements employed in other examples described herein is omitted for the sake of brevity.

At 902, the computer-implemented method 900 may comprise updating, by an apparatus 100 operatively coupled to a processor 102, BIOS instructions on a memory 205. In various examples, the BIOS update at 902 may be performed in accordance with method 500. For example, a BIOS update may be prompted by updated BIOS instructions 101, which may be received via a communication interface 202 and/or a network 210. In accordance with the examples described herein, the updating at 902 may be performed on a memory 205 that is non-volatile and accessible by multiple components, such as the processor 102 and a controller 104.

At 904, the computer-implemented method 900 may comprise transitioning, by the apparatus 100, a controller 104 and a processor 102 to an off state. In various examples, the controller 104 and the processor 102 may be transitioned to the off state based on the occurrence of the BIOS update at 902. At 906, the computer-implemented method 900 may comprise generating, by the apparatus 100, internal state machine variables descriptive of copying a boot block and/or driver execution region associated with the updated BIOS instructions 101. In various examples, the internal state machine variables may be generated by the controller 104 in accordance with method 700 based on a detection of the BIOS update performed at 902. At 908, the computer-implemented method 900 may comprise transitioning, by the apparatus 100, the controller 104 and the processor 102 to an on state.

Once the processor 102 and the controller 104 are in the on state, the computer-implemented method 900 may progress to 910 and 912. At 910, the computer-implemented method 900 may comprise executing, by the apparatus 100, the updated BIOS instructions 101 from the memory 205. In various examples, the processor 102 may execute the updated BIOS instructions 101 at 910 in accordance with method 802. At 912, the computer-implemented method 900 may comprise generating, by the apparatus 100, a copy of the boot block 212 in a memory 216. In various examples, the controller 104 may generate the copy of the boot block 212 in accordance with the non-transitory machine-readable storage media instructions 406 and/or method 800.

At 914, the computer-implemented method 900 may comprise copying, by the apparatus 100, the driver execution region associated with the updated BIOS instructions 101 to a private serial peripheral interface 106. In various examples, the controller 104 may generate a copy of the driver execution region 214 at 914 in accordance with non-transitory machine-readable storage media instructions 408 and/or method 800. For example, the driver execution region associated with the updated BIOS instructions 101 may be copied from the memory 205 to the private memory 204 via the private serial peripheral interface 106. At 916, the computer-implemented method 900 may comprise relocating, by the apparatus 100, the copy of the boot block 212 to the private memory 204 via the private serial peripheral interface 106 based on a successful signature verification operation. In various examples, the controller 104 may perform a signature verification operation, such as a public key infrastructure technique, on the copy of the boot block 212 while the copy of the boot block 212 is stored in the memory 216. Where the signature verification is successful, the controller 104 may relocate the copy of the boot block 212 from the memory to the private memory 204. For example, the relocation at 916 may be performed in accordance with the non-transitory machine-readable storage media instructions 410 and 412 of the non-transitory machine-readable storage medium 300 and/or method 800. At 918, the computer-implemented method 900 may comprise generating, by the apparatus 100, additional internal state machine variables that may clear the states and/or actions described by the internal state machine variables generated at 906.

In various examples, at least two features included within the dashed rectangle shown in FIG. 9 may be performed in parallel with each other. For example, at least one of the features described at 912, 914, 916, and/or 918 may be performed concurrently with execution of the updated BIOS instructions at 910. In other words, the execution of the updated BIOS instructions at 910 may be initialized while at least one of the features described at 912, 914, 916, and/or 918 is being performed.

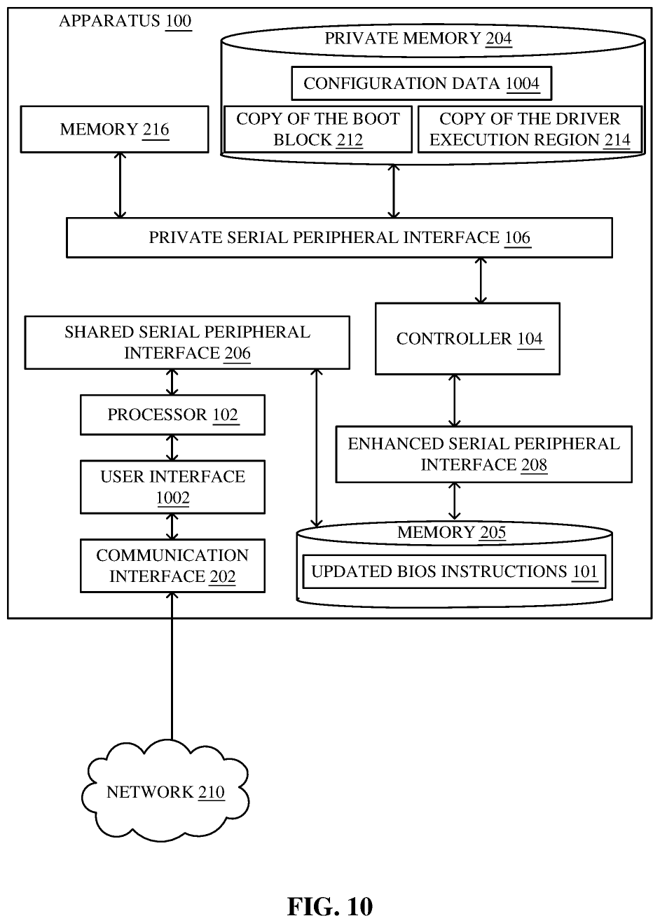

FIG. 10 illustrates a diagram of the example, non-limiting apparatus 100 further comprising a user interface 1002 and/or configuration data 1004 in accordance with examples described herein. Repetitive description of like elements employed in other examples described herein is omitted for the sake of brevity. As shown in FIG. 10, the user interface 1002 may be coupled to various components of the apparatus 100 directly and/or via the shared serial peripheral interface 206. Also shown in FIG. 10, the configuration data 1004 may be stored within the private memory 204 and accessible to the controller 104 via the private serial peripheral interface 106.

In various examples, the user interface 1002 may be employed to initiate a BIOS update by the processor 102 and/or a BIOS backup operation by the controller 104. For example, the processor 102 may perform the BIOS update and/or execute the updated BIOS instructions 101 in accordance with method 500 based on a user request received via the user interface 1002. In another example, the controller 104 may copy the updated BIOS instructions 101 to the private serial peripheral interface 106 based on a user request received via the user interface 1002. The user interface 1002 may comprise hardware and/or non-transitory machine-readable storage media instructions for entering a user request into the apparatus 100. Example types of user interfaces 1002 may include, but are not limited to: touchscreens, keyboards, mouse input devices, a combination thereof, and/or the like. Further, the user request may prompt the execution at least one of the methods and/or non-transitory machine-readable storage media instructions described herein.

In various examples, the configuration data 1004 may include file lifecyle management (“FLM”) that enables the controller 104 to program various commands and address ranges and/or block designated command and address combinations. For example, the controller 104 may apply a write protection command via the FLM to the region of the shared serial peripheral interface 206 associated with the boot block and/or driver execution region of the updated BIOS instructions 101. In another example, the controller 104 may program write and erase commands via the FLM along with the address range of the region associated with the boot block and/or driver execution region being read from the shared serial peripheral interface 206. Additionally, the configuration data 1004 may specify whether past versions of the BIOS instructions are to be kept in storage on the memory 205 and/or private memory 204.

While the examples have been described above in the general context of non-transitory machine-readable storage media instructions that may run on computers, those skilled in the art will recognize that the examples may be also implemented in combination with other program modules and/or as a combination of hardware and non-transitory machine-readable storage media instructions. Generally, program modules include routines, programs, components, data structures, and/or the like, that perform particular tasks or implement particular abstract data types.

The illustrated examples of the apparatus 100 herein may be also practiced in distributed computing environments where certain tasks are performed by remote processing devices that are linked through a communications network. In a distributed computing environment, program modules may be located in both local and remote memory storage devices.

What has been described above include mere examples of apparatuses, computing devices, computer program products and computer-implemented methods. It is, of course, not possible to describe every conceivable combination of components, products and/or computer-implemented methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various examples have been presented for purposes of illustration, but are not intended to be exhaustive or limited to the examples disclosed. Many modifications and variations will be apparent to those of ordinary skill in the art without departing from the scope and spirit of the described examples.

What is claimed is:

1. An apparatus, comprising:
a private serial peripheral interface;
a processor to execute updated basic input/output system (BIOS) instructions; and
a controller to copy the updated BIOS instructions to the private serial peripheral interface, wherein execution and copying of the updated BIOS instructions are performed concurrently.

2. The apparatus of claim 1, wherein the controller is to generate internal state machine variables based on a detection of the updated BIOS instructions, the controller to generate a copy of a boot block of the updated BIOS instructions and a copy of a driver execution region of the updated BIOS instructions via the internal state machine variables.

3. The apparatus of claim 2, wherein the copy of the boot block is stored in a memory, and wherein the copy of the driver execution region is stored via the private serial peripheral interface.

4. The apparatus of claim 3, wherein the copy of the boot block and the copy of the driver execution region are generated during the execution of the updated BIOS instructions.

5. The apparatus of claim 4, wherein the controller is to relocate the copy of the boot block from the memory to a private memory based on a signature verification operation.

6. An apparatus, comprising:
a first serial peripheral interface;
a second serial peripheral interface;
a processor to execute updated basic input/output system (BIOS) instructions; and
a controller to capture the updated BIOS instructions from the first serial peripheral interface to the second serial peripheral interface, wherein execution of the updated BIOS instructions is initiated prior to completion of a capture of the updated BIOS instructions.

7. The apparatus of claim 6, wherein the controller is to generate a copy of a boot block of the updated BIOS instructions from the first serial peripheral interface to a memory.

8. The apparatus of claim 7, wherein the controller is to copy a driver execution region of the updated BIOS instructions from the first serial peripheral interface to the second serial peripheral interface.

9. The apparatus of claim 8, wherein the controller is to relocate the copy of the boot block from the memory to a private memory based on a successful signature verification operation.

10. The apparatus of claim 9, wherein the first serial peripheral interface is a shared serial peripheral interface accessible to both the processor, and wherein the second serial peripheral interface is a private serial peripheral interface inaccessible to the processor.

11. A non-transitory machine-readable storage medium encoded with instructions executable by a controller, the non-transitory machine-readable storage medium comprising:
instructions to copy updated basic input/output system (BIOS) instructions from a first serial peripheral interface to a second serial peripheral interface, wherein a time period in which the updated BIOS instructions are copied overlaps another time period in which the updated BIOS instructions are executed.

12. The non-transitory machine-readable storage medium of claim 11, further comprising:
instructions to generate a copy of a boot block of the updated BIOS instructions based on a detection of the updated BIOS instructions; and
instructions to copy a driver execution region of the updated BIOS instructions to the second serial peripheral interface based on the detection of the updated BIOS instructions.

13. The non-transitory machine-readable storage medium of claim 12, wherein the copy of the boot block is stored in a memory, and wherein the non-transitory machine-readable storage medium further comprises:
instructions to execute a signature verification operation to determine whether the copy of the boot block is corrupted.

14. The non-transitory machine-readable storage medium of claim 13, further comprising:
instructions to relocate the copy of the boot block from the memory to a private memory based on a determination that the copy of the boot block is not corrupted.

15. The non-transitory machine-readable storage medium of claim 14, wherein the first serial peripheral interface is a shared serial peripheral interface accessible to a processor, and wherein the second serial peripheral interface is a private serial peripheral interface inaccessible to the processor.
